(19) United States
(12) Patent Application Publication
(10) Pub. No.: US 2017/0006380 A1
(43) Pub. Date: Jan. 5, 2017

(54) Front Enclosed In-Ear Earbuds

(71) Applicants: Garth W. Gobeli, Albuquerque, NM (US); Jean S. Gobeli, Albuquerque, NM (US); Brent W. Gordon, Albuquerque, NM (US)

(72) Inventors: Garth W. Gobeli, Albuquerque, NM (US); Jean S. Gobeli, Albuquerque, NM (US); Brent W. Gordon, Albuquerque, NM (US)

(21) Appl. No.: 15/237,864

(22) Filed: Aug. 16, 2016

Related U.S. Application Data
(63) Continuation-in-part of application No. 14/624,126, filed on Feb. 17, 2015.

(51) Int. Cl. H04R 3/04; H04R 29/00

(52) U.S. Cl. CPC H04R 3/04; H04R 29/001

(57) ABSTRACT

When an in-ear earbud is inserted into the ear canal, a front side sealed enclosure is created. The enclosure volume is sealed at the near end by the in-ear earbud and at the far end by the eardrum. The air trapped in the ear canal provides a stiff reactive volume that is comparable to the rear sealed enclosure volume provided by the earbud housing. An in-ear earbud simulator that closely replicates the ear canal volume and shape permits real-use measurements of the in-ear earbud frequency response. Such measurements lead to a transfer function that provides a frequency near flat frequency response. The transfer function is implemented with first order high pass and first order low pass circuits, either analog or digital in their embodiment. Additionally use of the approach for speech comprehension enhancement for cell phone conversations is implemented.

### CROSS REFERENCE TO RELATED APPLICATIONS

This is a Continuation in Part to application Ser. No. 14/624,126: Filing Date Feb. 17, 2015: Confirmation No: 5289: Attorney Docket No: GOBELI004.

### STATEMENT REGARDING FEDERALLY SPONSORED R&D

None.

### NAMES OF PARTIES TO A JOINT RESEARCH AGREEMENT

None.

### STATEMENT REGARDING PRIOR DISCLOSURES

None.

### FIELD OF THE INVENTION

This invention corrects sound reproduction deficiencies that are introduced by the large non-uniformities in earbud micro-transducer sound response as a function of audio frequency when the earbud is worn inserted into the ear canal.

### BACKGROUND OF THE INVENTION

### References

Large Hi-Fi systems use two or more speakers of different sizes and cross over networks to meld the sounds of the several speakers to provide a good reproduction of the original recorded sound. A rear enclosure that is sized with respect to the speaker size (diameter) is used to provide acoustic modification of each speaker's basic response characteristics as a function of acoustic frequency. Properly sized rear enclosures provide this modified characteristic because the contained air provides a restoring force to the speaker motion that is dominant compared to the electromagnetic driver suspension.

The use of speakers of different sizes and configurations with “crossover networks” being used to meld the speakers together into a single comprehensive unit can provide an extended “frequency near flat” range from 20 Hz to 20000 Hz.

The frequency response of an 8-inch (20.4 cm) diameter speaker has a free resonance of 35 Hz and the combination speaker with a properly designed sealed rear enclosure has a frequency independent response from just above resonance to more than 10,000 Hz. The drop off from 40 Hz to lower frequencies has a slope of about 12 dB per octave. (https://engineering.purdue.edu/ece103/LectureNotes/SRS_Loudspeaker_Parameters.pdf)

The data for this 8-inch speaker were taken with a receiving microphone positioned on the speaker axis at a distance of 4 meters and in an open environment (so that there can be no room reflections to complicate the measurements).

When a micro speaker is measured for its frequency response the experimental setup is very similar, except that the microphone-micro speaker separation is now 10 cm. Other than the smaller dimensions, this test setup is the same as that used for a large diameter speaker. The small size of the micro speaker causes its resonance frequency to be near 1000 Hz. Allowing for the different resonant frequencies, the two frequency response curves are quite similar. That is, for frequencies above the resonance frequency, the response is approximately independent of the frequency. As the test frequency declines, the response at 20 Hz declines to a value about 50-60 dB below the peak value, again with a decline of about 12 dB per octave. Thus, the micro speaker with the rear-covering component forming a rear enclosure behaves much as any speaker. (U.S. Patent Application Publication US 2007/0258598)

For micro speakers, there have been efforts to include several driver units inside each earbud to modify (correct) the frequency response but only with very limited success at a large price. (U.S. Pat. No. 9,055,366)

Some work directed to including two (or more) different size rear cavities (rear enclosures) that could have different frequency modulations of the micro speaker response have been proposed and patented. (U.S. Pat. No. 9,215,522, U.S. Pat. No. 9,363,594, U.S. Pat. No. 9,215,522, US 2013/0343593, US2016/0080859) None of these patents reference or discuss front side enclosures.

US2016/0080859 comments on the sealing of the earbud tip into the ear canal (in the background section) but makes no further note of its impact on earbud performance.

U.S. Pat. No. 3,985,960 Describes a method of modifying the frequency response of the microphone that is used to record sound (music) so that the recorded sound spectrum can be made to compensate for the characteristic of a “high quality commercial headphone”. The application of U.S. Pat. No. 3,985,960 would modify the recording medium itself rather than changing the “high quality headphone” characteristic.

We describe a straightforward method that provides the “ideal” transfer function for small in-ear earbud acoustic transducers, such as those in current large-scale use in earbud headphones. This results in an audio transducer that provides an output that precisely reproduces the input sound quality to the listener. The transducer thus has a “flat” reproduction for input sound; i.e. the reproduction is linear and independent of the sound frequency over a designated frequency range such as 16 Hz to 24,000 Hz.

### Definitions

Transducer: A device that senses an acoustic sound wave and converts variations in a physical quantity, such as sound pressure, into an electrical signal. Conversely, a device that converts an electrical signal into an acoustic sound wave is an acoustic transducer.

In-Ear Earbud: A small acoustic transducer that fits into the ear canal for listening to sound, be it music or speech. Such transducers seal the ear canal and produce a front sealed enclosure of the earbud micro speaker.

Not-In-Ear earbud: A type of earbud designed to sit loosely in the conch of the ear; generally held in place by a plastic retainer sitting in a fold of the conch.

Cell phone earpiece speaker: A small transducer positioned inside a mobile phone that provides speech sounds to the user when the phone is held to the ear. In mobile phones these are small rectangular micro-transducers.

Frequency response: The magnitude of the measured sound output by a (micro) speaker as a function of the audio frequency when the speaker is excited by an electrical drive circuit having a constant voltage of excitation at all frequencies.

Analog circuit: An instrument comprised of analog electronic components; capacitors, inductors, resistors, and discrete solid-state electronic devices.

Digital Signal Processor (DSP); a circuit composed of digital signal storage registers, digital data processors, etc.

In music an octave (Latin: octavus: eighth) or perfect octave is the interval between one musical pitch and another with half or double its frequency. Thus the frequency of sounds of 125 Hz, 250 Hz, 500 Hz, 1000 Hz, 2000 Hz, 4000 Hz, and 8000 Hz are all separated from the adjacent sounds by one octave.

The decibel (dB) is a logarithmic unit used to express the ratio of two values of a physical quantity, usually power or intensity. One of these values is often a standard reference value, in which case the decibel is used to express the level of the other value relative to this reference. The standard reference value for sound is 1×10⁻¹² Watts/ meter². The number of decibels is ten times the logarithm to the base 10 of the ratio of two power quantities. Thus a sound level of 90 dB (a very loud sound) is 1×10⁻¹²×1×10⁺⁹=10⁻³ watts per square meter=one milliwatt per square meter.

Pre-emphasis is a straightforward signal processing method that for the situational use here increases the amplitude of low frequencies and decreases the amplitudes of higher frequencies. For the case here, the frequencies from 50 Hz to 1050 Hz are increased by a first order filter at the rate of 6 dB per octave while all other frequency ranges are left unchanged.

A first order filter consists of a single resistor and a single capacitor; how the components are connected determines whether it is a high-pass or low-pass filter. The frequency response depends solely on the product of the resistance and the capacitance. Inductors can be used instead of capacitors; however, because of their larger size, they are not suitable for this application. The amplitude response of a first order filter changes by 6 dB per octave. Adding a second resistor-capacitor combination makes the filter second order with an amplitude response that changes by 12 dB per octave. Amplifiers are used to increase signal levels and isolate the filter elements from the rest of the circuit. Second and higher order filters result in greater attenuation, which require additional amplification. This additional amplification increases power consumption and noise. Higher order filters also cause dynamic range issues, especially for battery-operated circuits.

Transfer Function: A mathematical function relating the output or response of a system such as a filter circuit to the input or stimulus. For applications in acoustics, more specifically relating to the variations of response of a (micro) speaker as a function of the audio frequency. The transfer function can be estimated to be the inverse of the measured response function over the measured frequency range. The issue then is to fit the resulting (inverse response) vs. frequency curve by a choice of electronic filter characteristics, such as a combination of high and low-pass first order filters. After optimizing the component values and amplification levels circuits are fabricated and tested for performance. If necessary, component values can be changed to improve performance of the final design. If the response function is significantly complex, specifically if there are several really large local changes in the fundamental frequency response then it might be necessary to employ second order, and higher order, correction methods to achieve the desired “flat” response. In such a case much greater amplification, dynamic range and stability issues must be addressed in the final solution of the desired correction factor.

### BRIEF DESCRIPTION OF THE DRAWINGS

FIG. 1. Shows a graph of the frequency response of an 8-inch diameter “woofer” type of HiFi speaker.

FIG. 2. Shows the frequency response of a free-standing micro speaker in an open environment.

FIG. 3. Shows the “Ear Canal Simulator” necessary for proper evaluation of the frequency response of in-ear earbuds.

FIG. 4. Shows the extended frequency response of one in-ear earbud that has a 10 mm driver, a rare earth magnet (NdFeB) and a 6 micron membrane. Measurements were made with the simulator of FIG. 3.

FIG. 5. The frequency response of a smart phone earpiece speaker showing the indicated U.S.A. transmission bandwidth (400 Hz to 3400 Hz) together with the frequency locations of the various vocalized components of human speech.

### DETAILED DESCRIPTION OF THE INVENTION

High fidelity sound systems use speakers to replicate the sounds that are electronically recorded for future playback. All speakers, from the largest bass woofer (some 12 to 18 inch diameter) to the very small earbud micro speaker (9 to 10 mm, or 0.4 inch, diameter) share a common behavior. They have a native resonance frequency that scales with their size. An 8-inch diameter cone speaker has a free resonance value of 35 Hz while a 10 mm diameter high quality micro speaker has a resonance peak near 1000-1050 Hz.

Large scale Hi Fi systems use two or more speakers of different sizes and cross over networks to meld the sounds of the several speakers to provide a good reproduction of the original recorded sound. A rear enclosure that is sized with respect to the speaker size (diameter) is used to provide acoustic modification of each speaker's basic response characteristics as a function of acoustic frequency. Properly sized rear enclosures provide this modified characteristic because the contained air provides a restoring force to the speaker motion that is dominant compared to the electromagnetic driver suspension.

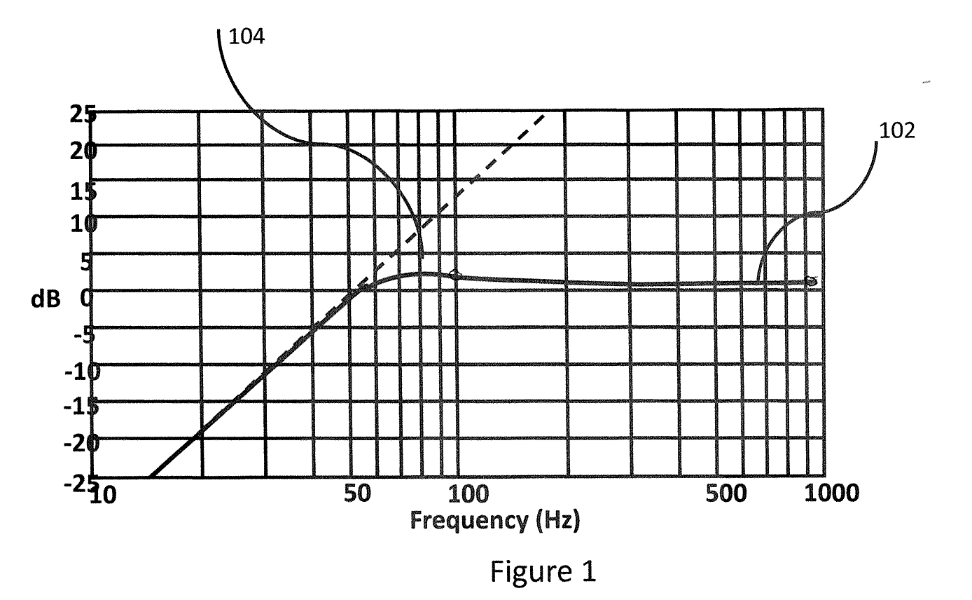

FIG. 1 shows the frequency response (102) of an 8-inch (20.4 cm) diameter speaker that has a free resonance of 35 Hz. The speaker with a properly designed sealed rear enclosure has a frequency independent response from just above resonance to more than 10,000 Hz.

As shown by the dotted line (104) the slope of the drop off from 40 Hz to lower frequencies has a value of 12 dB per octave.

These data were taken with a receiving microphone positioned on the speaker axis at a distance of 4 meters and in an open environment (so that there can be no room reflections to complicate the measurements).

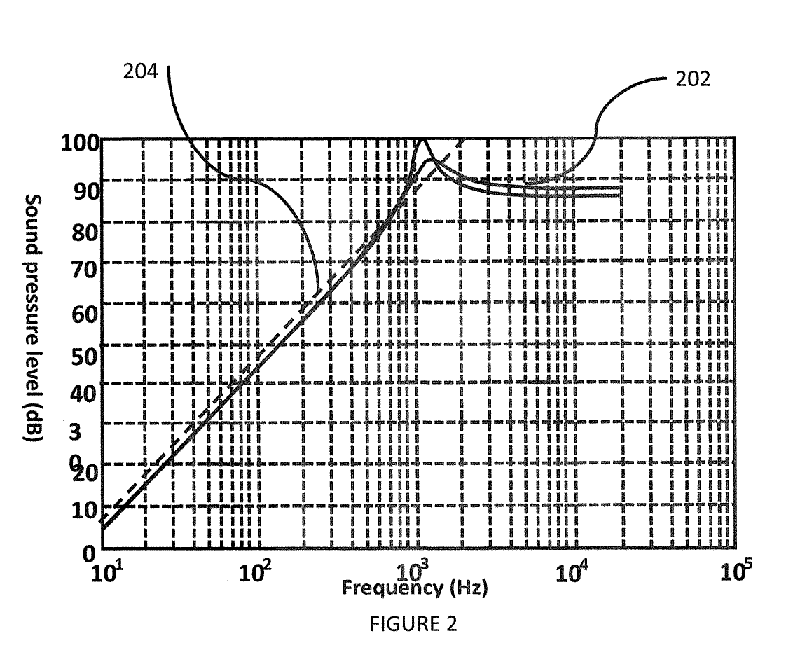

FIG. 2 shows a similar measurement for a micro speaker, such as those in smart phones or earbuds. Measurements for the frequency response uses an experimental setup that is very similar to that for large speakers, except that the microphone-to-micro speaker separation is now 10 cm. Other than the smaller dimensions, this test setup is the same as that used for a large diameter speaker. The small size of this micro speaker causes its resonance frequency to be near 1000 Hz. With that major change, the response curve (202) is a quite similar to the large speaker shown in FIG. 1. That is, for frequencies above the resonance frequency, the response is approximately independent of the frequency. As the test frequency declines, the slope of the response (204) declines to a value at 20 Hz of about 80 dB below the peak value, again with a decline of 12 dB per octave. Thus, the micro speaker with the rear-covering component forming a rear enclosure behaves much as any speaker.

When being used by individuals to listen, for example, to music, the earbud output tip is inserted securely into the outer region of the ear canal. The adult human ear canal is approximately 7 mm in diameter (3.5 mm radius) and 25 mm long according to Wikepedia. The front of the earbud sits inside a tube (the proximal end of the ear canal) that is approximately 7 mm in diameter and 25 mm long. The in-ear earbud seals this proximal end of the ear canal. The opposite end of the tube, (the distal end), is sealed by the eardrum. Thus a front-side sealed enclosure is formed that has a volume of π*r²*L=960 mm³.

A back-side enclosure of the earbud micro speaker is formed by the rear part of the case of the earbud itself. This back side enclosure for this 10 mm class earbud considered here, is a volume of approximately 10 mm diameter and 12 mm long and has a volume of π*r²*L=940 mm³.

Both enclosures represent a very “stiff” enclosure regardless of the specific construction, which means that they control the functioning of the micro speaker frequency response. Since the two volumes are roughly comparable they work approximately in opposition to one another on the functioning of the in-ear earbud speaker.

This combination of both a front-side and a back-side enclosure is unique to the proper functioning of an in-ear earbud micro speaker and is the focus of this disclosure. Only with proper measurements of the frequency response of micro speakers having both front side and back-side enclosures can the correct response function of the micro speaker be determined and the appropriate corrective measures be provided to achieve a desired functionality, such as frequency independent response.

The only instance where a “front side” enclosure is useful is for the case where the distant end of the enclosure is the eardrum itself. All other front side closures attenuate the sound emission unacceptably.

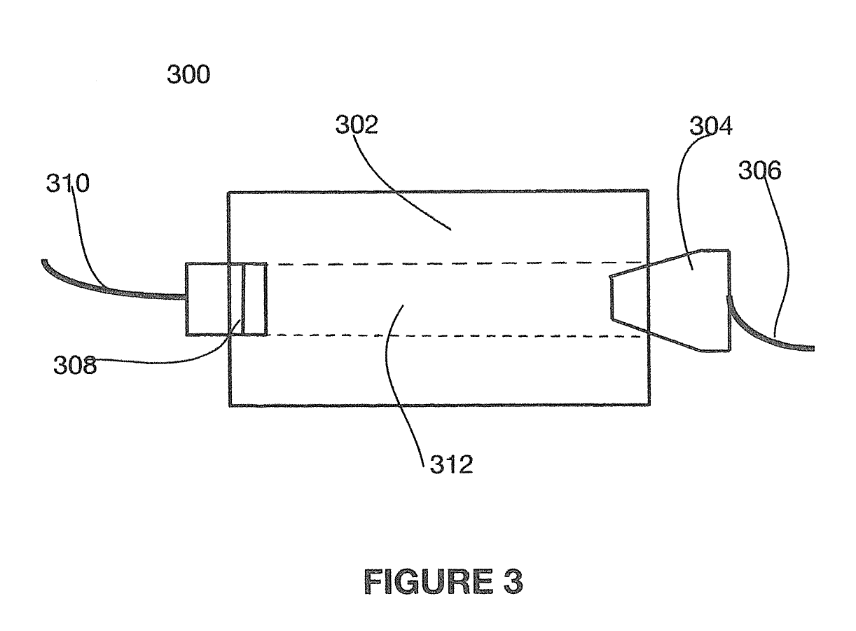

FIG. 3 shows the cut away diagram of the in-ear earbud simulator used for all response measurements of in-ear earbud micro speakers discussed here.

The heart of the simulator is a piece of thick wall rubber tubing (302) that has a ¼″ (6.25 mm) bore (312). One end has a ¼″ (6.25 mm) diameter microphone (308) that is connected via cable (310) to the measuring system input. The opposite end has an in-ear earbud (304) securely inserted with its electrical connection (306) leading to the constant amplitude frequency scan instrumentation. The length of the tube is adjusted to provide a separation between microphone (306) and in-ear earbud micro speaker (304) of 25 mm. Thus the use condition when the earbud is positioned into a user's ear is satisfied as being the same as for the simulation arrangement.

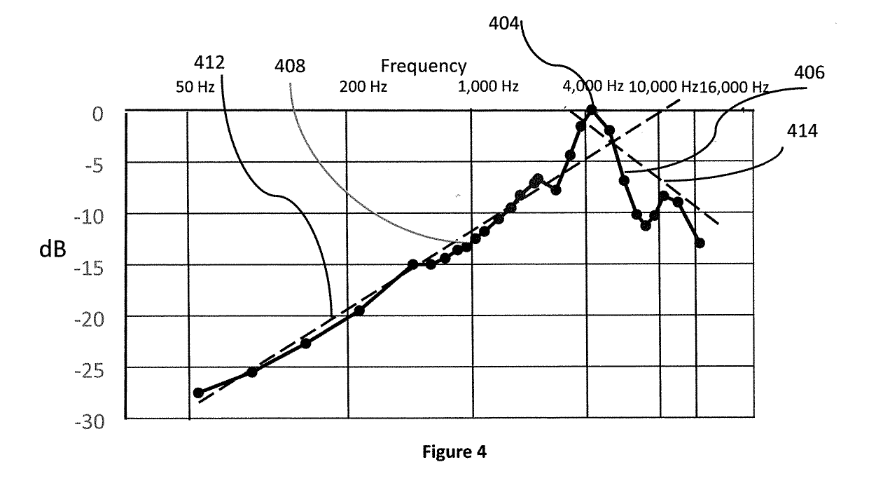

FIG. 4 shows the results of the frequency response measurement of in-ear earbuds that have a driver size of 10 mm, a rare earth magnet (NdFeB), and a 6 micron thick membrane. (This description identifies a high quality in-ear earbud.)

The results are significantly different from the results measured for a micro speaker that is exposed to the ambient laboratory environment shown in FIG. 2. The experimental condition for FIG. 2 is for the open separation of micro speaker and detection microphone, i.e. the classical measurement with source and detector separated by a relatively large path (100 mm).

The results from the simulator measurements show a distinct maximum in response (404) at a frequency of 4000 Hz. The frequency range below 4000 Hz (408) has a characteristic slope of 5 dB per octave as shown by dashed line (412). The overall slope, including the peak (404) at 4000 Hz has a slope of 6 dB per octave. The slope value for the high frequency region (406) above 4000 Hz has a characteristic slope (414) of 5 dB per octave and a “peak inclusive” slope of 6.5 dB per octave.

The in-ear earbud transfer function to achieve a frequency independent characteristic is derived from this measured frequency vs. audio response data. The response function, when applied to the data of FIG. 4, will produce a first order correction to the response characteristic and will produce a frequency independent in-ear earbud sound characteristic.

The transfer function requirements are significantly less than the 12 dB per octave reported for FIG. 2 (and FIG. 1) and it means that a basic first-order low frequency pass filter will provide excellent correction for this earbud. For this case the total decline from the peak value to the 20 Hz value is 30 dB rather than the 70 plus dB reported for the micro speaker evaluated in FIG. 2. Thus significant filtering and amplification problems of high order filters are not encountered here.

Either an analog or a DSP circuit will perfectly satisfy the same characteristic correction. The performance that can be achieved by an analog circuit for this case can also be performed by a properly designed digital signal processor (DSP) system. A combination of analog and digital circuits can also produce the needed transfer function.

In an alternate embodiment, the invention can be applied as a speech comprehension enhancement (SCE) method for cell phones.

The earbud correction of the audio transducers using the analog system (or by using the digital modification) and amplifier can be connected to the hands-free port of a mobile phone and, when connected, will provide an enhanced voice sound to the user. This is because the connection of the earbuds to the hands-free port disables the mobile phone earpiece speaker and transfers the sound to the modified earbuds. Even with the limited bandwidth for voice transmission (400 Hz to 3400 Hz in the U.S.A.) the sounds, especially those enhanced from about 1100 Hz to the lower cut-off value of 400 Hz provide a significant improvement in speech comprehension, since those speech sounds are significantly attenuated by the original transducer response.

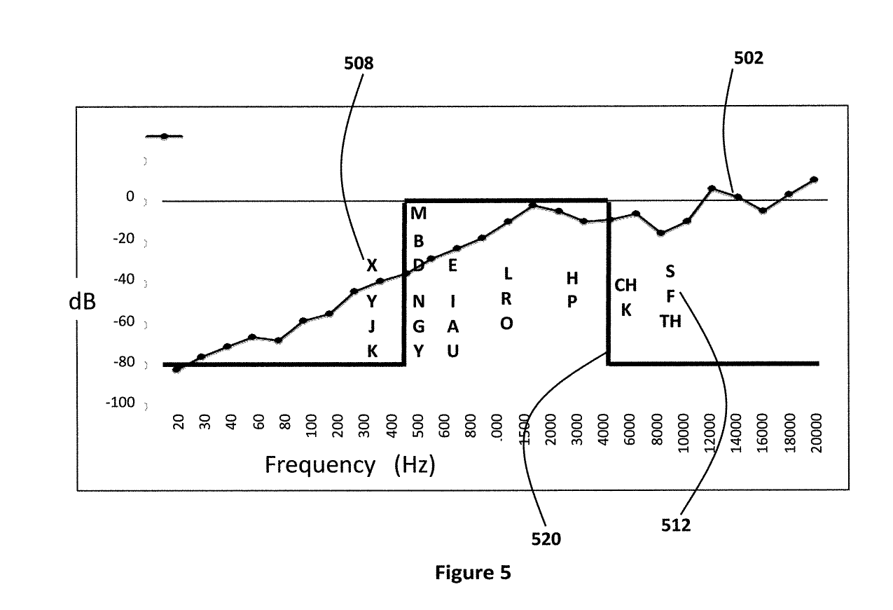

This deficiency in the small rectangular earpiece transducers of smartphones is a significant feature that we address here. In this case, the frequency range from 400 Hz to 3400 Hz is the domain of concern for mobile phone systems in the U.S.A. since that is the frequency range of transmission for vocal sounds of the entire telephone system. FIG. 5 shows the frequency response of a small rectangular micro speaker (502) with the U.S.A transmission bandwidth superimposed (520) as measured by the conventional stand off method used by micro speaker manufacturers. The response curve (502) reaches a negative 90 dB for very low frequencies (less than 20 Hz), 35 dB at 400 Hz, and plus or minus 10 dB for higher frequencies (from 1100 Hz to 20000 Hz).

The mnemonic alphabetic representations of the components of human speech are shown; from the sibilants (512) through midrange to the gutturals (508). It shows that the sibilants and the gutturals are not present in the received frequency range.

It is noted that for the rest of the world, the frequency range of transmission is from 70 Hz to 7000 Hz. Thus all vocal sounds are transmitted at some amplitude everywhere except in the United States.

However, even though the high frequency sibilants (512) are received for the international phone networks, they comprise only a quite small minority of speech sounds and as such they do not add significantly to speech comprehension.

The gutturals (508) on the other hand lie where the rectangular earpiece speaker has a frequency response is at best about minus 36 dB at 400 Hz on down to minus 80 dB at 30 Hz. K and X sounds are at about 30 Hz to 45 Hz.

Since the frequency of normal speech ranges from a low value of about 30 Hz to about 8000 Hz, this restriction has a negative impact on speech comprehension. However only a few speech sounds reside below 400 Hz, notably the guttural consonants X, Y, J, and K. Since these sounds make up only a very small fraction of speech the transducer correction provides significant improvements of speech comprehension even when limited by the U.S.A. transmission bandwidth.

For this situation, the improvement is due to the restoration of the lower frequencies (from 400 Hz to 1200 Hz). The strong attenuation of mid range speech sounds, particularly the vowels that are located at 600 to 700 Hz, account for the major factor in poor speech comprehension for smart phone voice communications (as well as for landline speech communications). See FIG. 5 (520). The absence of the gutturals X, Y, J, K (508) does not significantly impact speech recognition or comprehension, although the gutturals do have a small assistance for some small class of words and for speakers with exceptionally low frequency speech sounds.

The approach given here provides the majority of the improvement in speech comprehension that is possible for mobile phone communications. The overall simplicity of the approach shows that the implementation cost and straightforward electronic implementation offer an excellent cost/reward solution/improvement for speech comprehension enhancement (SCE) for mobile and landline communication.

FIG. 5 illustrates that the compensation correction should reach about 25 db at 400 Hz relative to 3400 Hz. This is about 9 dB per octave and is slightly outside the value that can be fully compensated by first order circuits. However the first order correction available from relative simple approaches will reduce this value to an overall value of about a 6 dB deficiency at 400 Hz relative to 3400 Hz.

In light of the very significant difference in earbud performance under measurement by “stand alone” as compared to “in-ear” measurements that a similar concern should be considered for resident smart phone earpiece speakers. Specifically does the in-phone mounting details impact the rear enclosure and its functionality? Does the positioning of the speaker outlet port very close to the ear impact speaker performance caused by a vented front enclosure? A “leaky” seal such as that presented by the contact between the ear conch and the smart phone surface is analytically a “vented” or “ported” enclosure. Generally vented enclosures are larger for similar correction behavior than sealed enclosures.

The geometry of the “vented enclosure” formed cannot be measured or estimated to any precision that suggests a calculation can be of real value. Thus a method of measuring the behavior of the smart phone earpiece speaker provides the better approach.

By imposing a first order low-pass filter that covers the frequency range from 1100 Hz to 200 Hz, the frequency region over which the significant loss in speech recognition exists, is addressed. The amplification range is about 14 dB from 1100 Hz to 200 Hz, which is easily attained by a first order filter circuit. The full amplification to 20 Hz is not attended here due to the service provider bandwidth cut off at 400 Hz.

Local frequency irregularities in the response curve will be corrected by higher order filter circuits, if additional correction is necessary for higher quality speech comprehension enhancement. Certainly, almost all of the available improvement will be implemented by use of the first order filter.

For wireless cell phone services outside the United States the transmission bandwidth for consideration is 70 Hz to 7000 Hz. The same analysis/considerations apply, but in this case over the expanded bandwidth.

Similarly, the evaluation of the class of earbuds that are designed to simply sit into a fold of the ear conch to provide listening (generally to music) can have their frequency response impacted by a un-obvious front enclosure effect. Specifically, just as the case that the smart phone earpiece speaker has a “vented” type of front enclosure terminated by the eardrum, the same consideration about a non-in-earbud must be measured for effective and precise in-use evaluation.

A first order correction over the frequency range from 16 Hz to 24,000 Hz by a set of high-pass and low-pass filters has been designed. The designed provides an approximately flat frequency response and results in a very significant improvement in listening quality. Any localized frequency variations of the earbud response will be addressed through higher order filters.

What is claimed is:

1. An ear canal simulator for modeling and measuring the acoustic response of an in-ear earbud that is inserted into the ear canal of the human ear, the simulator comprising;
a sealed, instrumented front side enclosure,
said enclosure having a volume between 600 cubic millimeters and 1400 cubic millimeters,
an in-ear earbud being inserted into one aperture of said enclosure,
a precision microphone being inserted into a second aperture of said enclosure.

2. An ear canal simulator according to claim 1 in which said volume is a cylindrically shaped flexible tube with an internal diameter between 4 mm and 12 mm and length from 12 mm to 45 mm with said two apertures at opposite ends of said flexible cylindrical tube.

3. A method of modifying the audio signal replication by an earbud speaker in a sealed front side enclosure, the method comprising:
Determining the volume of said sealed front side enclosure,
Fabricating an instrumented sealed front side enclosure having a means of accepting an in-ear earbud micro speaker,
Said sealed front side enclosure also having a means of accepting a microphone,
Driving the speaker with a variable frequency audio signal,
Instrumentally measuring the resulting audio signal replication in the sealed front side enclosure,
Determining the difference between the driving audio signal and the resultant audio signal replication,
Determining a desired difference between the audio signal and the desired audio signal replication,
Deriving a transfer function describing the difference between the audio signal and the resulting audio signal replication,
Configuring an electrical circuit comprised of low-pass and high pass elements to effect the transfer function, and
Inserting said electrical circuit between the audio signal and the in-ear earbud micro speaker.

4. The method of modifying the audio signal replication by an earbud speaker in a sealed front side enclosure of claim 3, wherein:
The electrical circuit is comprised of first order low-pass and first-order high-pass filter elements to effect the signal transfer function.

5. A method of modifying the audio signal replication by a cell phone earpiece micro speaker, the method comprising:
Obtaining the frequency characteristic of a standard cell phone earpiece micro speaker,
Determining a signal transfer function needed to provide the desired frequency characteristic of said cell phone earpiece micro speaker,
Configuring an electrical circuit comprised of first order low-pass and high-pass filter elements to effect the signal transfer function,
Inserting the electrical circuit into the cell phone prior to the cell phone earpiece micro speaker.

6. The method of modifying the audio signal replication by a cell phone earpiece micro speaker of claim 5, wherein:
The electrical circuit is comprised of first order low-pass and first-order high-pass filter elements to effect the signal transfer function.
